(19) United States
(12) Patent Application Publication
(10) Pub. No.: US 2008/0112024 A1
(43) Pub. Date: May 15, 2008

(54) IMAGE PROCESSING APPARATUS, IMAGE PROCESSING METHOD, IMAGE PROCESSING PROGRAM, RECORDING MEDIUM STORING IMAGE PROCESSING PROGRAM, AND IMAGE DISPLAY APPARATUS

(75) Inventor: Hidekuni MORIYA, Suwa-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/872,434

(22) Filed: Oct. 15, 2007

(30) Foreign Application Priority Data
Nov. 9, 2006 (JP) 2006-304045
Aug. 24, 2007 (JP) 2007-217893

(51) Int. Cl. G03F 3/08

(52) U.S. Cl. 358/518

(57) ABSTRACT

An image processing apparatus for performing processing for converting a color space of image data includes a color conversion section which acquires wide color gamut image data and converts the wide color gamut image data into image data in a standard wide color gamut space, and a transmission section which transmits the image data converted by the color conversion section to a display section capable of displaying the image data in the standard wide color gamut space.

### BACKGROUND

1. Technical Field

The present invention relates to a technical field of an image processing apparatus, an image processing method, an image processing program, a recording medium storing an image processing program, and an image display apparatus each for executing processing on image data.

2. Related Art

In the past, processing for converting the color space of image data has been executed in image processing apparatuses. For example, in JP-A-2002-152544, there is described a technology for executing color space conversion based on the color space adopted when an image is shot by a camera, thereby reproducing the image. Further, in JP-A-2005-341500, there is described a technology for converting the color space taking the color space of the output device (a display apparatus) into consideration.

However, in the case in which a circuit (hereinafter referred to as “a color conversion circuit”) for executing conversion of the color space described in the documents mentioned above is realized as hardware, the color conversion circuit must be changed in some cases in consideration of the color space of the display apparatus when the optical characteristic of the display apparatus has varied. Since it requires tremendous amounts of time and money to change the circuit as hardware as described above, it can be said that it should spoil the convenience in designing a display apparatus.

### SUMMARY

In view of the above circumstances, an advantage of some aspect of the invention is to provide an image processing apparatus, an image processing method, and an image processing program, a recording medium storing an image processing program, and an image display apparatus each capable of converting the color space in an unspecified manner independently of the optical characteristic of a display section.

According to an aspect of the invention, there is provided an image processing apparatus for performing processing for converting a color space of image data including a color conversion section which acquires wide color gamut image data and converts the wide color gamut image data into image data in a standard wide color gamut space, and a transmission section which transmits the image data converted by the color conversion section to a display section capable of displaying the image data in the standard wide color gamut space.

The image processing apparatus described above is preferably used for performing the processing for converting the color space of the image data. The color conversion section acquires wide color gamut image data and converts the wide color gamut image data into image data in a standard wide color gamut space. Further, the converted image data in the standard wide color gamut space is transmitted to the display section and is displayed thereon. Thus, it becomes possible to perform the processing for converting the color space in an unspecified manner independently of the optical characteristic in the display section. Therefore, since even in the case of changing the display section, the circuit for performing the color conversion is hardly required to be modified as hardware, the image display apparatus can quickly be designed, thus enhancing the convenience of the designers.

The standard wide color gamut space is preferably expressed by the Adobe RGB. The Adobe RGB system is widely used as wide color gamut, and is a proper setting in, or example, the case of handling the input image from the digital still camera.

Further preferably, the xy chromaticity in the standard wide color gamut space is (0.64, 0.33) in red, (0.21, 0.71) in green, and (0.15, 0.06) in blue.

In the aspect of the image processing apparatus described above, the color conversion section can acquire, as the wide color gamut image data, one of a first luminance color difference signal, a second luminance color difference signal different from the first luminance color difference signal, and a wide color gamut RGB signal.

In the image processing apparatus described above, the color conversion section preferably switching, the processing in accordance with the type of the wide color gamut image data, thereby performing the conversion. Thus the processing corresponding to the various types or wide color gamut image data can appropriately be performed, and accordingly, the image data can correctly be reproduced. In other words, in accordance with input of the various wide color gamut image data, the color space information of an image can be reproduced with good accuracy.

According to another aspect of the invention, there is provided an image display apparatus including an image processing apparatus having a color conversion section which acquires wide color gamut image data and converts the wide color gamut image data into image data in a standard wide color gamut space, and a transmission section which transmits the image data converted by the color conversion section to a display section, and a display section which displays the image data in a standard wide color gamut space transmitted from the image processing apparatus. According to the image processing apparatus, since the processing for converting the color space can be performed in an unspecified manner independently of the optical characteristic of the display section, the circuit for performing the color conversion is hardly required to be modified as hardware, it becomes possible to quickly design the image display device.

In a preferable aspect, the display section can be a liquid crystal display which performs display using tour colors, and is configured including a color filter of red, yellow-green, blue, and emerald-green, and a white LED backlight.

In another preferable aspect, the display section can perform display using three colors.

According to another aspect of the invention, there, is provided an image processing method for performing processing for converting a color space of image data-including the steps of acquiring wide color gamut image data to convert the wide color gamut image data into image data in a standard wide color gamut space, and transmitting the image data converted in the acquiring step to a display section capable of displaying the image data in the standard wide color gamut space.

According to still another aspect of the invention, there is provided an image processing program for making a computer perform processing for converting a color space of image data, the processing including the steps of acquiring wide color gamut image data to convert the wide color gamut image data into image data in a standard wide color gamut spacer and transmitting the image data converted in the color conversion section to a display section capable of displaying the image data in the standard wide color gamut space.

Also by executing the image processing method or the image processing program described above, it becomes possible to perform the processing for converting the color space in an unspecified manner independently of the optical characteristic in the display section.

It should be noted that as the recording medium storing the image processing program, various computer readable medium such as a flexible disk, a CD-ROM, or an IC card can be used.

### BRIEF DESCRIPTION OF THE DRAWINGS

The invention will now be described with reference to the accompanying drawings, wherein like numbers refer to like elements.

FIG. 1 is a block diagram showing a schematic configuration of an image display apparatus according to a first embodiment of the invention.

FIG. 2 is a diagram showing color reproduction areas in the xy chromaticity diagram.

FIGS. 3A through 3C are diagrams showing specific numerical values as the xy chromaticity in the first embodiment.

FIGS. 4A through 4D are diagrams showing spectroscopic characteristics of a color filter and so on in each pixel.

FIG. 5 is a diagram clotting the xy chromaticity of a four-primary-color LCD and the xy chromaticity of colors reproduced by the four-primary-color LCD when inputting Adobe RGB.

FIG. 6; is a block diagram showing a schematic configuration of a color conversion circuit according to the first embodiment of the invention.

FIG. 7 is a diagram for explaining the color space conversion by a linear transformation.

FIG. 8 is a diagram showing an anterior gamma table.

FIG. 9 Is a diagram showing a posterior gamma table.

FIG. 10 is a block diagram showing a schematic configuration of a color conversion circuit according to a second embodiment of the inventor.

FIG. 11 is a diagram showing data calculated from various types of standard three-primary-color signals when defining the tristimulus values XYZ of 33 colors.

FIGS. 12A through 12C are diagrams showing a u′ v′ chromaticity plot of the input data and a u′ v′ chromaticity plot with measured values of the various types of standard three-primary-color signals.

FIG. 13 is a diagram showing color reproduction areas in the xy chromaticity diagram in a third embodiment of the invention.

FIGS. 14A through 14C are diagrams showing specific numerical values as the xy chromaticity in the third embodiment.

FIGS. 15A and 15B are diagrams showing a spectroscopic characteristic and so on in each pixel section.

FIG. 16 is a diagram plotting the xy chromaticity of a three-primary-color LCD and the xy chromaticity of colors reproduced by the three-primary-color LCD when inputting Adobe RGB.

### DESCRIPTION OF EXEMPLARY EMBODIMENTS

Hereinafter, preferred embodiments of the present invention will be described with reference to the accompanying drawings.

### First Embodiment

Firstly, a first embodiment of the invention will be explained.

### Overall Configuration

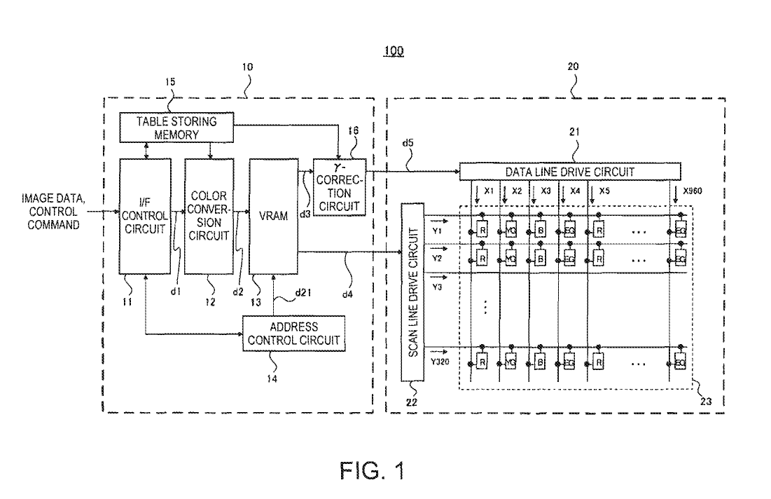

FIG. 1 is a block diagram showing a schematic configuration of an image display apparatus 100 according to a first embodiment of the invention. The image display apparatus 100 is provided with an image processing section 10 for acquiring image data and control commands from the outside to execute image processing on the image data, and a display section 20 for displaying the image data on which the image processing is executed by the image processing section 10. It should be noted that the image display apparatus 100 is configured to be able to display images using multiple colors (hereinafter a fundamental color used for displaying images is referred to as “a primary color”). Specifically, the image display apparatus 100 is configured to be able to display four primary colors (hereinafter also referred to simply as “R.” “YG,” “B,” and “EG”) of Red, Yellow Green, Blue, and Emerald Green.

The image processing section 10 is provided with an I/F control circuit 11 a color conversion circuit 12, a video RAM (VRAM) 13, an address control circuit 14, a table storing memory 15, and a γ-correction circuit 16. It should be noted that the image data input to the image processing section 10 is expressed as three-primary-color signals (signals corresponding to wide color gamut image data, hereinafter referred to as “standard three-primary-color signals”) as certain standard signals.

The I/F control circuit 11 acquires the image data and the control commands from the outside (e.g., a camera), and supplies the color conversion circuit 12 with the image data d1. The color conversion circuit 12 processes the image data d1 thus acquired together with the color space information. Further, the color conversion circuit 12 executes processing for converting the image data, which is obtained by the present processing, from a three-primary-color system into a four-primary-color system. For example, the color conversion circuit 12 is configured including a circuit for executing color conversion in the form of a three dimensional look-up table, and is capable of executing the conversion from the three-primary-color system to the four-primary-color system using this circuit. As described above, the color conversion circuit 12 corresponds to the image processing apparatus accordion to the embodiment of the invention. Specifically, the color conversion circuit 12 functions as a color conversion section. The details of the processing in the color conversion circuit 12 will be described later.

The image data d2 on which the image processing is executed by the color conversion circuit 12 is written into the VRAM 13. The image data d2 thus written into the VRAM 13 is retrieved by the γ-correction circuit 16 as image data d3 accordance with a control signal d21 from the address control circuit 14. Simultaneously, an address signal d4 corresponding to data not yet displayed is supplied to a scan line drive circuit 22 in the display section 20. Thus, it becomes possible that a data line drive circuit 21 and the scan line drive circuit 22 drive a display panel 23 in sync with each other. Further, the γ-correction circuit it executes the γ-correction on the image data d3 thus acquired based on the correction data stored in the table storing memory 15. Further, the γ-correction circuit 16 supplies the data line drive circuit 21 in the display section 20 with image data d5 on which the γ-corrections been executed.

The display section 20 is provided with the data line drive circuit 21, a scan line drive circuit 22, and the display panel 23. The data line drive circuit 21 supplies 960 data lines with data line drive signals X1 through X960, and the scan line drive circuit 22 supplies 320 scan lines with scan line drive signals Y1 through Y320. For details, the scan line drive circuit 22 selects a pixel row in the lateral direct on at a constant frequency, and the data line drive circuit 21 supplies the pixel row selected by the scan line drive circuit 22 with respective drive signals. In this case, the data line drive circuit 21 and the scan line drive circuit 22 should drive the display panel 23 in sync with each other. The display panel 23 is composed of a liquid crystal device (LCD) and so on, and displays images such as characters or pictures to be displayed thereon in response to application of voltages on the scan lines and the data lines. Further, the display panel 23 is configured to be able to display the four primary colors of R, YG, B, and EG described above.

It should be noted that although the VRAM 13 is an effective measure for reducing the power consumption in the case in which the same display data is repeatedly displayed, the image display apparatus 100 can be configured without using the VRAM 13 if there is no sticking to the reduction of the power consumption. In such a case, display is performed while the address control circuit 14 and the scan line drive circuit 22 are directly connected to each other, and the scan line drive circuit 22 and the data line drive circuit 21 are in sync with each other.

Further, although an example of forming the display section 20 using the LCD is described above, any display devices other than the LCD can be used as the display section for performing multi-primary-color display. For example, a device for performing planar display such as CRT, PDP, OLED, or FED, and a display device for performing projection such as LCP or PTV can be used therefor.

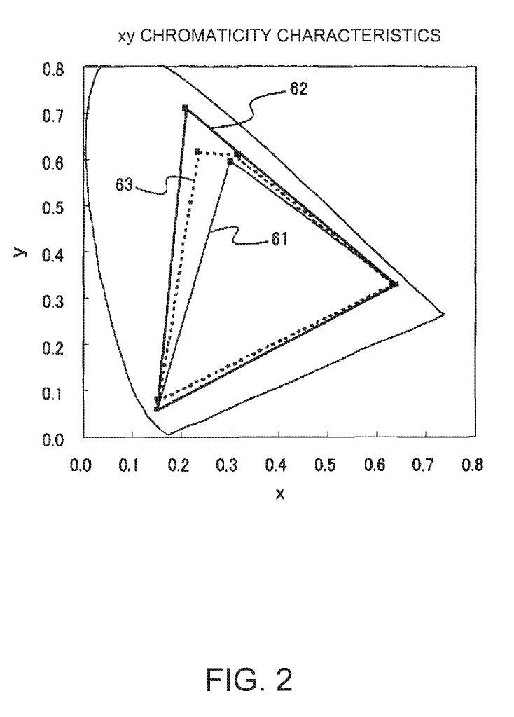

The color reproduction areas in the xy chromaticity diagram will hereinafter be explained with reference to FIG. 2. The triangle denoted with the reference numeral 61 is a color reproduction area of “sRGB,” which is widely used as a standard color space (hereinafter, R, G, and B in the sRGB are also described as “Rₛ,” “Gₛ,” and “Bₛ,” respectively). Further, the triangle denoted with the reference numeral 62 is a color reproduction area of “Adobe RGB,” which is of standard use as a wide color gamut (hereinafter, R, G, and B in the Adobe RGB are also described as “R_{A},” “G_{A},” and “B_{A},” respectively). It should be noted that the Adobe RGB corresponds to a standard wide color gamut space.

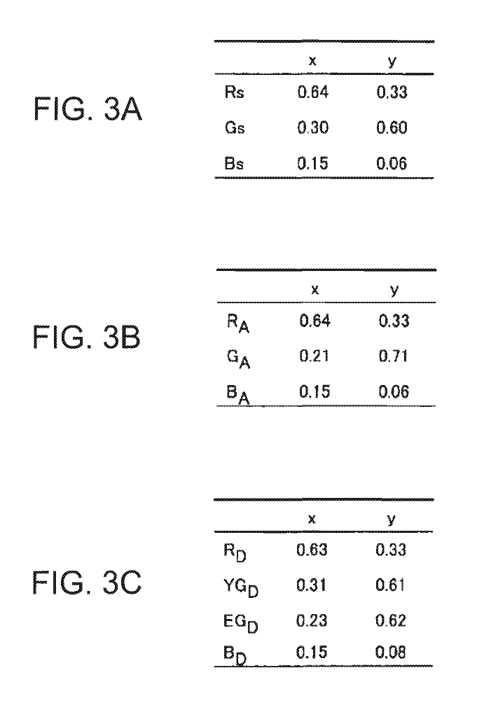

In the image display apparatus 100 described above, by using the four primary colors of R, YG, B, and EG, the colors inside the rectangle denoted with the reference numeral 63 can be reproduced (hereinafter, the four primary colors used by the image display apparatus 100 is also described as “R_{D},” “YG_{D},” “EG_{D},” and “B_{D}”). According to FIG. 2, it proves that the color reproduction area using the four primary colors is wider than the color reproduction area of the standard sRGB. Therefore, according to the image display apparatus 100, brighter colors can be reproduced in the emerald greenish colors than in the sRGB system. For reference, FIGS. 3A through 3C show specific numerical values of the xy chromaticity in “R_{S}, G_{S}, B_{A},” “R_{A}, G_{A}, B_{A},” and “R_{D}, YG_{D}, EG_{D}, B_{D}” described above.

Here, in the present embodiment, the image processing section 10 in the image display apparatus 100 has a circuit, which is set so as to reproduce the color reproduction area of the Adobe RGB. For details, the color conversion circuit 12 of the image processing section 10 performs processing for converting the standard three-primary-color signal (corresponding to wide color gamut image data) input thereto into data (corresponding to image data in the standard wide color gamut space) of Adobe RGB. Further, the color conversion circuit 12 also executes the processing for converting the image data obtained by the above processing from a three-primary-color signal into a four-primary-color signal.

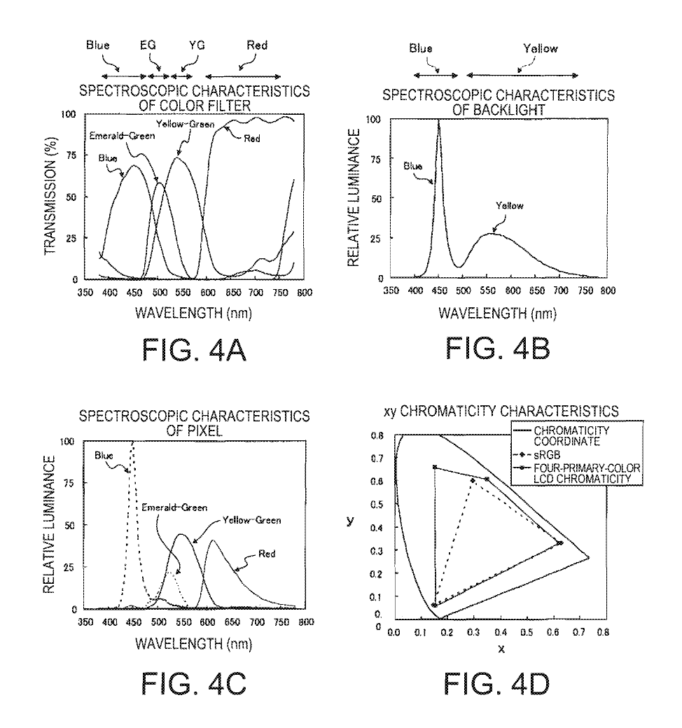

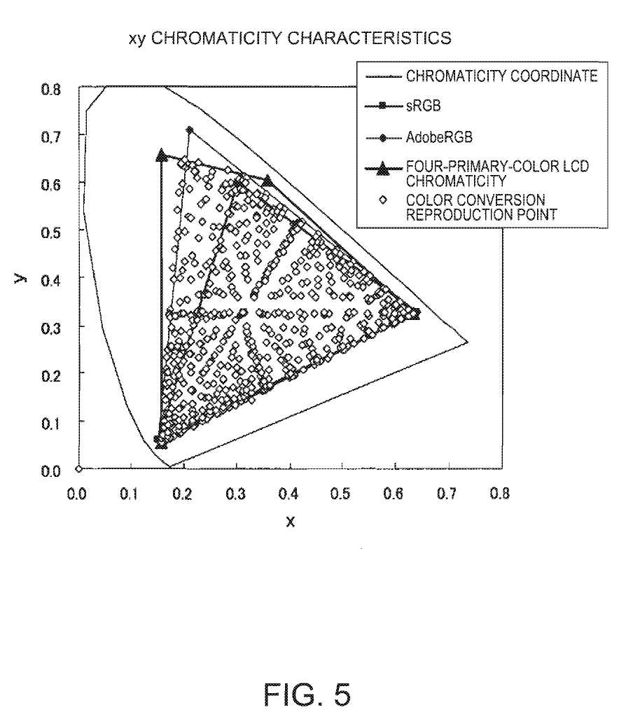

The fact that the color conversion circuit 12 is set so as to reproduce the color reproduction area of the Adobe RGB as described above will hereinafter be explained with reference to FIGS. 4A through 4D, and 5.

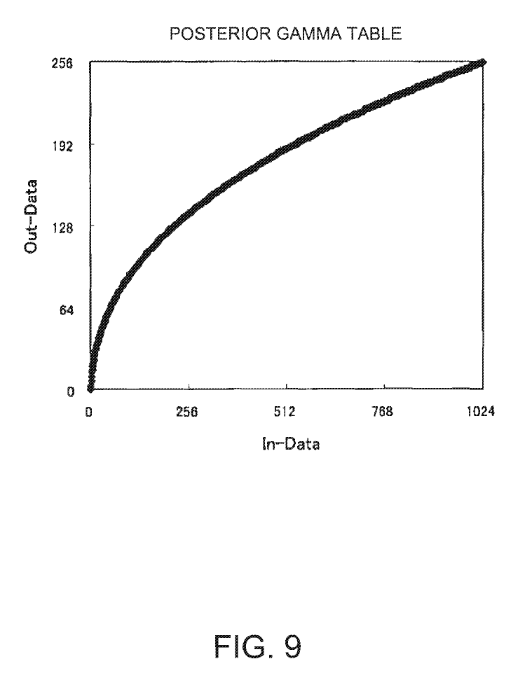

FIGS. 4A through 4D are diagrams showing spectroscopic characteristics of a color filter and so on in each pixel. FIG. 9A is a diagram having the horizontal axis representing wavelengths and the vertical axis representing transmissions and showing the characteristics of the color filters of the R, YG, B, and EG pixel sections collectively. FIG. 4B has the horizontal axis representing wavelengths and the vertical axis representing relative luminance and shows the spectroscopic characteristic of a white LED backlight (a blue LED combined with a fluorescent material). FIG. 4C is a diagram having the horizontal axis representing wavelengths and the vertical axis representing relative luminance and shows the spectroscopic characteristics in light emission of the R, YG, B, and EG pixel sections collectively. FIG. 4D is a diagram showing the xy chromaticity characteristics in the sRGB system and the xy chromaticity characteristics in the four-primary-color LCD. Regarding the xy chromaticity characteristic of the four-primary-color LCD, the xy chromaticity is calculated and plotted based on the spectroscopic characteristics in light emission of the R, YG, B, and EG pixels.

FIG. 5 is a diagram plotting the xy chromatic xy of the four-primary-color LCD and the xy chromaticity of colors reproduced by the four-primary-color LCD when the Adobe RGB signal is input thereto. In this case, the conversion from the three-primary-color system to the four-primary-color system is executed by the color conversion circuit 12. By performing, for example, the color conversion in the form of the three-dimensional look-up table, the three-primary-color signal in the Adobe RGB system can be converted to reproduce it as a color inside the four-primary-color LCD. It should be noted that the points shown in FIGS. 2 and 3C as the rectangle (the rectangle denoted with the reference numeral 63) represented by R_{D}, YG_{D}, EG_{D}, and B_{D} correspond to four representative points of the colors after converted into the four-primary-color LCD shown in FIG. 5.

Incidentally, the colors in the vicinity of the green apex in the Adobe RGB system exist outside the color reproduction area of the four-primary-color LCD, and accordingly, can hardly be reproduced directly. Even such colors, by appropriately setting the color conversion circuit 12, can approximately be reproduced as the colors inside the four-primary-color LCD without causing any uncomfortable feeling. On the contrary, the colors respectively corresponding to the Yellow-Green and Emerald-Green apexes exist outside the color reproduction area of the Adobe RGB system. These colors do not exist in the Adobe RGB system input thereto, and accordingly, are not reproduced after the color conversion.

The reason why the color reproduction characteristics of the four-primary-color LCD can be approximated to the color reproduction area of the Adobe RGB system is the design of the spectroscopic characteristics of the color filters and the backlight. Specifically, by designing the spectroscopic characteristics, the xy chromaticity particularly red and blue) calculated from the emission characteristics of the pixel section is approximated to the Adobe RGB system. It should be noted that the reason why the Adobe RGB system is referred to is because the Adobe RGB is acknowledged as a wide color gamut, and widely used as a standard.

As described above, in the present embodiment, the color conversion circuit 12 in the image processing section 10 converts the data of the Adobe ROB system from the three-primary-color system into the four-primary-color system. Therefore, prior to executing such a color conversion, the color conversion circuit 12 firstly executes the processing for converting the standard three-primary-color signals input thereto into the Adobe RGB system. Hereinafter, the processing of converting the standard three-primary-color signal into the Adobe RGB system, which is executed by the color conversion circuit 12, will be explained specifically. Processing in Color Conversion Circuit

The processing in tie color conversion circuit 12 according to the present embodiment will be explained specifically.

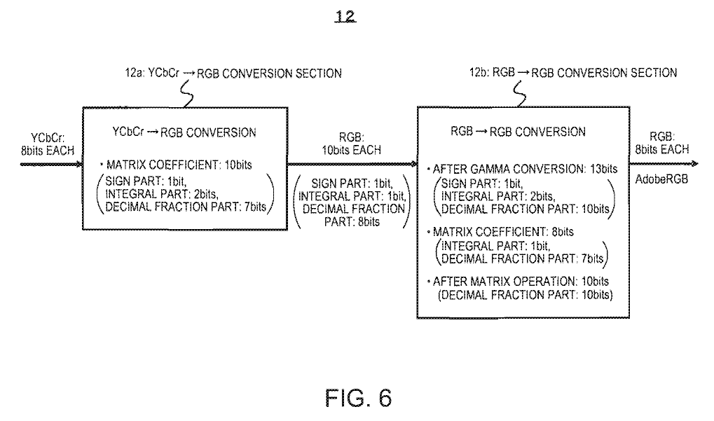

FIG. 6 is a block diagram showing a schematic configuration of the color conversion circuit 12. The color conversion circuit 12 is provided with a YCbCr→RGB conversion section 12a and an RGB→RGB conversion section 12b. YCbCr data (8bits) expressed by Y (luminance) and Cb, Cr (color differences) is input to the color conversion circuit 12. For details, the YCbCr data is a picture signal stipulated by “ITU-R BT.601.” it should be noted that in FIG. 6, in the color conversion circuit 12, only the processing section for converting the image data input thereto into the Adobe RGB data is shown, but the processing section For converting the image data from three-primary-color signal into the four-primary-color signal is not shown.

The YCbCr→RGB conversion section 12a mainly performs processing of converting the YCbCr data input thereto into the RGB data. Specifically, the YCbCr→RGB conversion section 12a performs an operation for converting the YCbCr data into RGB data using a coefficient (hereinafter also referred to as “a matrix coefficient”, expressed in 10bits (a sign part: 1bit, an integral part: 2bits, and a decimal fraction part: 7bits). Thus, the RGB data including R data, G data, and B data each composed of 10bits (the sign part: 1bit, the integral part: 1bit, and the decimal fraction part: 8bits) can be obtained. The YCbCr→RGB conversion section 12a supplies the RGB→RGB conversion section, 12b with the RGB data thus obtained. It should be noted that as a result of the processing by the YCbCr→RGB conversion section 12a, the data corresponding to the sRGB can be obtained.

The RGB→RGB conversion section 12b mainly performs processing of converting the RGB data, which is obtained by the YCbCr→RGB conversion section 12a, into the Adobe RGB system. In other words, the RGB→RGB conversion section 12b performs the processing of converting the sRGB compatible data obtained by the conversion by the YCbCr→RGB conversion section 12a into the Adobe RGB data having a wide color gamut. For details, the RGB→RGB conversion section 12b firstly performs a gamma conversion (hereinafter, this gamma conversion is referred to as “an anterior gamma conversion”), then performs the matrix operation (specifically, the RGB→RGB conversion), and finally performs the gamma conversion (hereinafter, this gamma conversion is referred to as “a posterior gamma conversion”) The reason why the gamma conversions are thus performed is because the data obtained by the YCbCr→RGB conversion has already been gamma-converted.

Specifically, by executing the anterior gamma conversion, data in 13bits (the sign part: 1bit, the integral part: 2bits, and the decimal fraction part: 10bits) can be obtained Then, the RGB→RGB conversion is executed on the data on which the anterior gamma conversion has been executed using the matrix coefficient expressed in 8bits (the integral part: 1bit, and the decimal fraction part: 7bits), namely the matrix operation is executed. The operation is the processing for converting the sRGB compatible data into the Adobe RGB system. As a result of the RGB→RGB conversion, 10bit (the decimal fraction part: 10bits) data can be obtained. Then, by executing the posterior gamma conversion on the data on which the RGB→RGB conversion has been executed, 8bit (the decimal fraction part: 8bits) data can be obtained. As described above, the 8bit RGB data (specifically, the Adobe RGB data) is output from the RGB→RGB conversion section 12b. After then, the color conversion from the three-primary-color system into the four-primary-color system is executed in a circuit, which is not shown in the drawings, inside the color conversion circuit

Hereinafter, the processing in the YCbCr→RGB conversion section 12a and the RGB→RGB conversion section 12b described above will be explained in further detail. YCbCr→RGB Conversion

In the present embodiment, the YCbCr→RGB conversion section 12a performs the conversion described above using the generally used YCbCr→RGB conversion (in other words, the YCbCr→RGB conversion compliant to the “ITU-R BT.601 standard”).

Here, the generally used YCbCr→RGB conversion wilt be explained. In the “ITU-R BT.601 standard,” the conversion from the YCbCr signal into the RGB signal is executed using Formula 1 as follows. In this case, the matrix coefficient is expressed as shown in Formula 2.

$$\begin{matrix}\begin{matrix}[ \begin{matrix}R 1 \\ G 1 \\ B 1\end{matrix} ] = [ \begin{matrix}1.0000 & 0.0000 & 1.4020 \\ 1.0000 & - 0.3441 & 0.5000 \\ 1.0000 & 1.7720 & 0.0000\end{matrix} ] [ \begin{matrix}255 / 219 & 0 & 0 \\ 0 & 255 / 224 & 0 \\ 0 & 0 & 255 / 224\end{matrix} ] [ \begin{matrix}( {Y}_{8} - 16 ) / 255 \\ ( C {b}_{8} - 128 ) / 255 \\ ( C {r}_{8} - 128 ) / 255\end{matrix} ] \\ = [ \begin{matrix}1.1644 & 0.0000 & 1.5960 \\ 1.1644 & - 0.3917 & - 0.8129 \\ 1.1644 & 2.0172 & 0.0000\end{matrix} ] [ \begin{matrix}( {Y}_{8} - 16 ) / 255 \\ ( C {b}_{8} - 128 ) / 255 \\ ( C {r}_{8} - 128 ) / 255\end{matrix} ]\end{matrix} & ΛFormula 1 \\ [ \begin{matrix}1.1644 & 0.0000 & 1.5960 \\ 1.1644 & - 0.3917 & - 0.8129 \\ 1.1644 & 2.0172 & 0.0000\end{matrix} ] ⇒ [ \begin{matrix}149 & 0 & 204 \\ 149 & - 44 & - 104 \\ 149 & 258 & 0\end{matrix} ] & ΛFormula 2\end{matrix}$$

In Formula 1, the left matrix is the inverse matrix of the RGB→YCbCr conversion matrix stipulated in the “ITU-R BT.601” because the YCbCr→RGB conversion is performed). Further, since in the “ITU-R BT.601,” the luminance Y and the color differences Cb, Cr are expressed by “16 through 235” and “16 through 240,” respectively, the right matrix is used for restoring the ranges of these signals to “0 through 255.” It should be noted that the “R1, G1, and B1” in Formula 1 show the RGB data after the YCbCr→RGB conversion has been executed, and the “Y₈, Cb₈, and Cr₈” show the YCbCr data, which is a target of the YCbCr→RGB conversion. Hereinafter, they should be treated in the same way.

### RGB→RGB Conversion

Then, the RGB→RGB conversion executed by the RGB→RGB conversion section 12b will be explained. The RGB→RGB conversion is performed in order for converting the sRGB compatible data (see FIGS. 2 and 3A) obtained by the YCbCr→RGB conversion described above into the Adobe RGB data with the wider color gamut.

Such RGB→RGB conversion can be explained using the concept of the linear transformation. Here, the explanations will be presented taking the linear transformation in a two-dimensional space as an example (although the color space is a three-dimensional space, the concepts are the same, and accordingly the two-dimensional space is taken as an example in view of easiness in explanations).

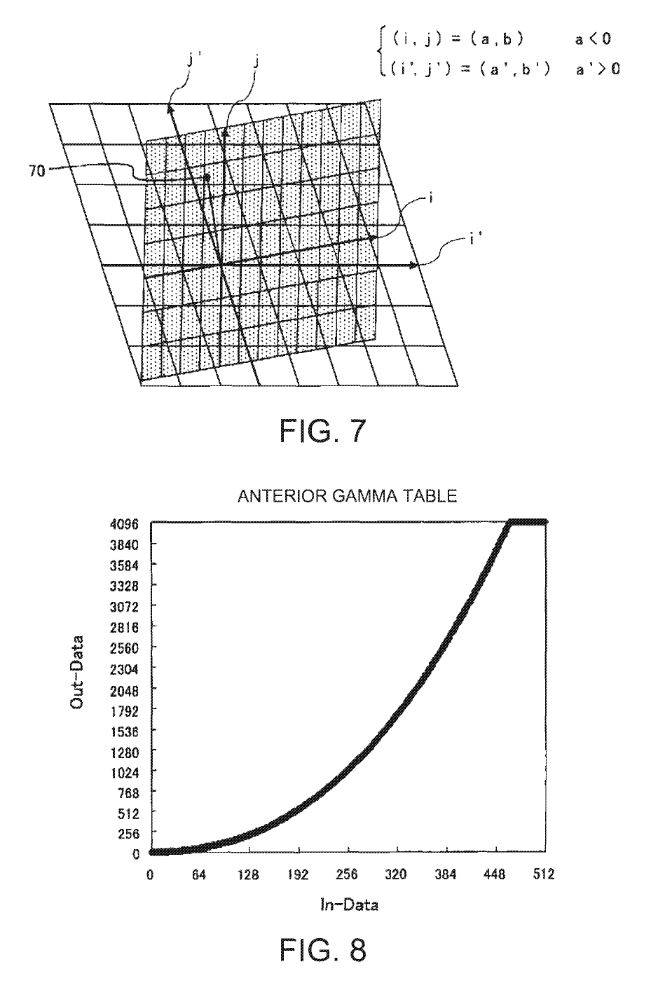

FIG. 7 is a diagram for explaining the color space conversion by a linear transformation. Here, the case in which a point 70 illustrated with a black circular dot is linearly transformed on a two-dimensional space will be explained. Specifically, the black circular dot 70 is represented as (a, b) in the coordinate axes (i, j), and when the coordinate axes are transformed to (i′, j′) by the linear transformation, it is represented as (a′, b′) As described above, the RGB→RGB conversion can be thought to be a concept of performing the conversion of the coordinates. In other words, although the colors are the same, it corresponds to representing the data, which is represented by the sRGB, by the Adobe RGB.

Further, paying attention to the coordinate a, although in the coordinate axes (i, j) before the linear transformation, a takes a negative value as In “a<0,” in the coordinate axes (i′, j′) after the linear transformation, a′ takes a positive value as in “a′>0.” In other words, the negative value is converted into the positive value by the linear transformation. In this example, it is shown that the coordinate, which has been expressed as the negative value, can be expressed as the positive value depending on now the coordinate axes are selected. This concept can be applied to the colors, a pixel (=coordinate), which has been expressed as a negative value before converting the color space (=before the linear transformation of the coordinate axes), can be expressed as a pixel (=coordinate) with a positive value after converting the color space (=after the linear transformation of the coordinate axes).

Specifically, although after the YCbCr→RGB conversion, the color space is set to the sRGB system, in order for holding the information of the wider color space, value smaller than “0,” and value larger than “1” are held as numerical values. In the present embodiment, as described above, the YCbCr→RGB conversion section 12a inputs the 10bit data (sRGB data) composed of 8bits of decimal fraction part, 1bit of integral part, and 1bit of sign part to the RGB→RGB conversion section 12b, and the RGB→RGB conversion section 12b, while holding the information, performs the processing for converting it into the Adobe RGB having a wider color space.

In this case, although the RGB→RGB conversion is a linear operation, the data on which the YCbCr→RGB conversion has been executed is a data on which a gamma conversion has been executed. Therefore, the RGB→RGB conversion section 12b performs the anterior gamma conversion, the matrix operation (the RGB→RGB conversion), and the posterior gamma conversion described above.

In the anterior gamma conversion, the conversion expressed by Formula 3 as follows. It should be noted that “R2” in Formula 3 denotes the data of R after the anterior gamma conversion, while “R1” denotes the data of R after the YCbCr→RGB conversion described above. Further, since the conversion formula is common to R, G, and B, only R is shown here as a representative.

$$R 2 = \{ \begin{matrix}- {( ( - R 1 + 0.055 ) / 1.055 )}^{2.4} & R 1 < - 0.04045 \\ R 1 / 12.92 & - 0.04045 \leq R 1 \leq 0.04045 \\ {( ( R 1 + 0.055 ) / 1.055 )}^{2.4} & R 1 > 0.04045\end{matrix} \qquad ΛFormula 3$$

In this case, the conversion formula shown in Formula 3 can be configured in the actual circuit as a table (hereinafter referred to as “an anterior gamma table”) in the ROM (since it is positive-negative symmetric, only the positive side is configured) FIG. 8 shows the anterior gamma table. In FIG. 8, the horizontal axis represents the input value (In-Data), and the vertical axis represents the output value (Out-Data) of the anterior gamma conversion. The input of the anterior gamma table is the data on which the YCbCr→RGB conversion has been executed and composed of 9bits including 8bits of decimal fraction part and 1bit of integral part. The output of the anterior gamma conversion includes 10bits of decimal fraction part and 2bits of integral part (totally 13bits including 1bit of sign part) taking the fact that the conversion characteristic is convex downward and increases as an exponential function into consideration.

Subsequently, the matrix operation shown in Formula 4 below is executed in the RGB→RGB conversion. In this case, the matrix coefficient is expressed with 7bits of decimal fraction part and 1bit of integral part as shown in Formula 5. It should be noted that the “R3, G3, and B3” in Formula 4 show the RGB data after the RGB→RGB conversion has been executed thereon, and the “R2, G2, and B2” show the RGB data after the anterior gamma conversion described above.

$$\begin{matrix}[ \begin{matrix}R 3 \\ G 3 \\ B 3\end{matrix} ] = [ \begin{matrix}0.715 & 0.285 & 0.000 \\ 0.000 & 1.000 & 0.000 \\ 0.000 & 0.041 & 0.959\end{matrix} ] [ \begin{matrix}R 2 \\ G 2 \\ B 2\end{matrix} ] & ΛFormula 4 \\ [ \begin{matrix}0.715 & 0.285 & 0.000 \\ 0.000 & 1.000 & 0.000 \\ 0.000 & 0.041 & 0.959\end{matrix} ] ⇒ [ \begin{matrix}92 & 36 & 0 \\ 0 & 128 & 0 \\ 0 & 5 & 123\end{matrix} ] & ΛFormula 5\end{matrix}$$

Subsequently, in posterior gamma conversion, the conversion expressed by Formula 6 as follows. It should be noted that “R4” in Formula 6 denotes the data of R after the posterior gamma conversion, while “R3” denotes the data of R after the RGB→RGB conversion described above. Further, since the conversion formula is common to R, C, and B, only R is shown here as a representative.

$$R 4 = \{ \begin{matrix}0 & R 3 < 0 \\ R 3 \times 12.92 & R 3 \leq 0.0031308 \\ 1.055 \times R {3}^{( 1.0 / 2.4 )} - 0.055 & R 3 > 0.0031308 \\ 1 & R 3 > 1\end{matrix} \qquad ΛFormula 6$$

As is the case with the anterior gamma table, the conversion formula shown in Formula 6 can be configured in the actual circuit as a table (hereinafter referred to as “a posterior gamma table”) In the ROM (the outputs of the posterior gamma conversion are all positive) FIG. 9 shows the posterior gamma table. In FIG. 9, the horizontal axis represents the input value (In-Data), and the vertical axis represents the output value (Out-Data) of the posterior gamma conversion. The input of the posterior gamma table is assumed to be composed of 10bits of decimal fraction part with bits to be assigned to the sign and integral parts rounded. Further, the output of the posterior gamma conversion becomes 8bits of decimal fraction part. After then, on the 8bit data (the data of the Adobe RGB system) on which the posterior gamma conversion is executed, the color conversion from the three-primary-color system to the four-primary-color system is further executed by the circuit not shown inside the color conversion circuit

As described above, in the first embodiment, the standard three-primary-color signal input thereto is converted into the Adobe RGB system, and also the Adobe RGB system obtained by the conversion is color-converted from the three-primary-color system into the four-primary-color system Thus, in the YCbCr→RGB conversion section 12a and the RGB→RGB conversion section 12b inside the color conversion circuit 12, the color space conversion process can be performed in an unspecified manner independently of the optical characteristic of the image display apparatus 100. Further, the Adobe RGB system obtained by the color space conversion processing is widely used as a wide color gamut, and is a proper setting in the case, for example, of handling the input image from the digital still camera. By using such a configuration, the color conversion circuit 12 is hardly required to be modified as hardware even if the display section 20 is changed, and accordingly, the image display apparatus can quickly be designed, thus enhancing the convenience of the designers.

### Second Embodiment

A second embodiment of the invention will hereinafter be described. The second embodiment is different from the first embodiment in that although in the first embodiment described above, the processing is executed only on the YCbCr data (for details, the signal for a picture stipulated in the “ITU-R BT.601,” hereinafter referred to as “expanded color gamut YCbCr”) as the standard three-primary-color signal, in the second embodiment, the processing is executed on several types of standard three-primary-color signals. Specifically, in the second embodiment, totally four types of standard three-primary-color signals including the expanded color gamut YCbCr described above are input to the color conversion circuit, and performs the YCbCr→RGB conversion and the RGB→RGB conversion thereon. For details, as the standard three-primary-color signals, four types of signals of standard YCbCr, the expanded color gamut YCbCr, standard RGB, and optional RGB are input to the color conversion circuit. In this case, the standard RGB corresponds to the sRGB, while the optional RGB corresponds to the Adobe RGB. The color conversion circuit in the second embodiment is provided with either one of these standard three-primary-color signals inputs thereto, and switches the processing in accordance with the type of the input one of the standard three-primary-color signals to execute the YCbCr→RGB conversion and the RGB→RGB conversion thereon.

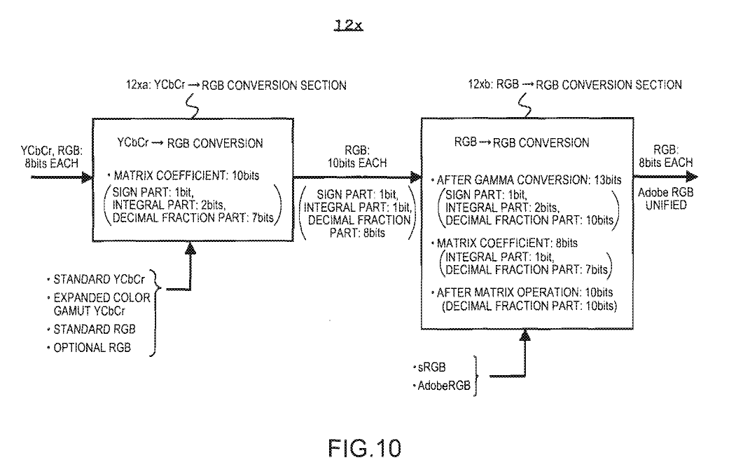

FIG. 10 shows a block diagram of the color conversion circuit 12x in the second embodiment of the invention. It should be noted that the color conversion circuit 12x is applied to the image processing section 10 (see FIG. 1) instead of the color conversion circuit 12.

The color conversion circuit 12x includes a YCbCr→RGB conversion section 12xa and an RGB→RGB conversion section 12xb. The YCbCr→RGB conversion section 12xa and the RGB→RGB conversion section 12xb respectively perform substantially the same processing as the YCbCr→RGB conversion section 12a and the RGB→RGB conversion section 12b in the color conversion circuit 12 described above. However, the YCbCr→RGB conversion section 12xa and the RGB→RGB conversion section 12xb switch the processing to be executed in accordance with the type of the standard three-primary-color signal input thereto. In this case, the YCbCr→RGB conversion section 12xa and the RGB→RGB conversion section 12xb respectively perform switching of the processing in response to a control command supplied from, for example, a CPU in a host system (not shown). Hereinafter, the processing executed in accordance with the type of the standard three-primary-color signal will be explained.

In the case in which the expanded color gamut YCbCr signal compliant to the “ITU-R BT.601” is input, the YCbCr→RGB conversion section 12xa performs the same operations (see Formulas 1 and 2) as described above. On the other hand, if The standard YCbCr signal is input, the YCbCr→RGB conversion section 12xa performs the conversion from the YCbCr signal to the RGB signal using the Formula 7 below.

$$[ \begin{matrix}R 1 \\ G 1 \\ B 1\end{matrix} ] = [ \begin{matrix}1.0000 & 0.0000 & 1.4020 \\ 1.0000 & - 0.3441 & - 0.7141 \\ 1.0000 & 1.7720 & 0.0000\end{matrix} ] [ \begin{matrix}{Y}_{8} / 255 \\ ( C {b}_{8} - 128 ) / 255 \\ ( C {r}_{8} - 128 ) / 255\end{matrix} ] \qquad ΛFormula 7$$

The matrix in Formula 7 is the same as the left matrix in the right-hand side of Formula 1.

Further, in the case in which the standard RGB signal or tile optional RGB signal is input, the YCbCr→RGB conversion section 22xa does not perform the operational processing (namely skips the operational processing). This is because the signal is originally the RGB data, and accordingly, there is no need for converting form the YCbCr data into the RGB data. It should be noted that such switching of the processing in the YCbCr→RGB conversion section 12xa is performed based on the control command described above.

After the YCbCr→RGB conversion is executed, the RGB→RGB conversion section 12xb executes the RGB→RGB conversion. Specifically, in the case in which one of the standard YCbCr signal, the expanded color gamut YCbCr signal, and the standard RGB signal is input to the YCbCr→RGB conversion section 12xa, since it is converted into the sRGB compatible color space by the YCbCr→RGB conversion, the RGB→RGB conversion section 12xb converts it in to the Adobe RGB system by performing the same operational processing as shown in Formulas 3 through 6 described above. On the other hand, in the case in which the optional RGB is input to the YCbCr→RGB conversion section 12xa, since the optional RGB is originally the Adobe RGB, the RGB→RGB conversion section 12xb does not perform the operational processing (namely skips the operational processing). It should be noted that such switching of the processing in the RGB→RGB conversion section 12xb is performed based on the control command described above.

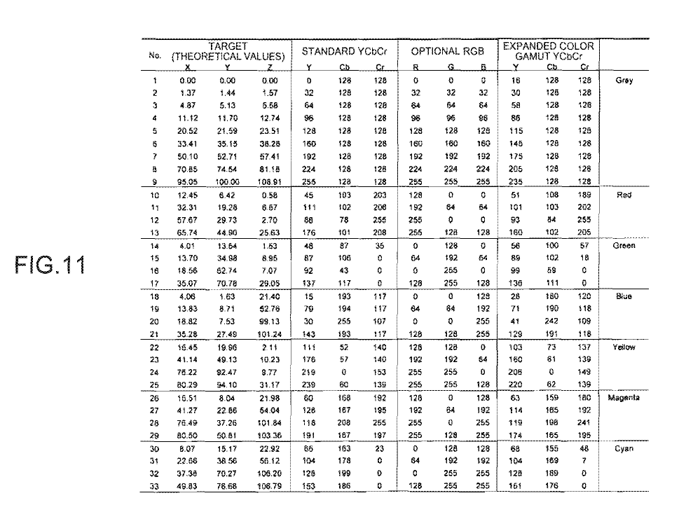

Then, whether the standard YCbCr signal, the expanded color gamut YCbCr signal, the standard RGB signal, and the optional RGB signal are appropriately color-converted in the color conversion circuit 12x according to the second embodiment is verified. In the verification, tristimulus values XYZ of 33 colors are defined, and the data corresponding to the standard YCbCr, the expanded color gamut YCbCr, and the optional RGB is calculated respectively. FIG. 11 shows a list of the calculation results. It should be noted that since the 33 colors described above are designated on the basis of the optional RGB, and include bright colors, which cannot be expressed in the standard RGB system, the data in the standard RGB is omitted in FIG. 11.

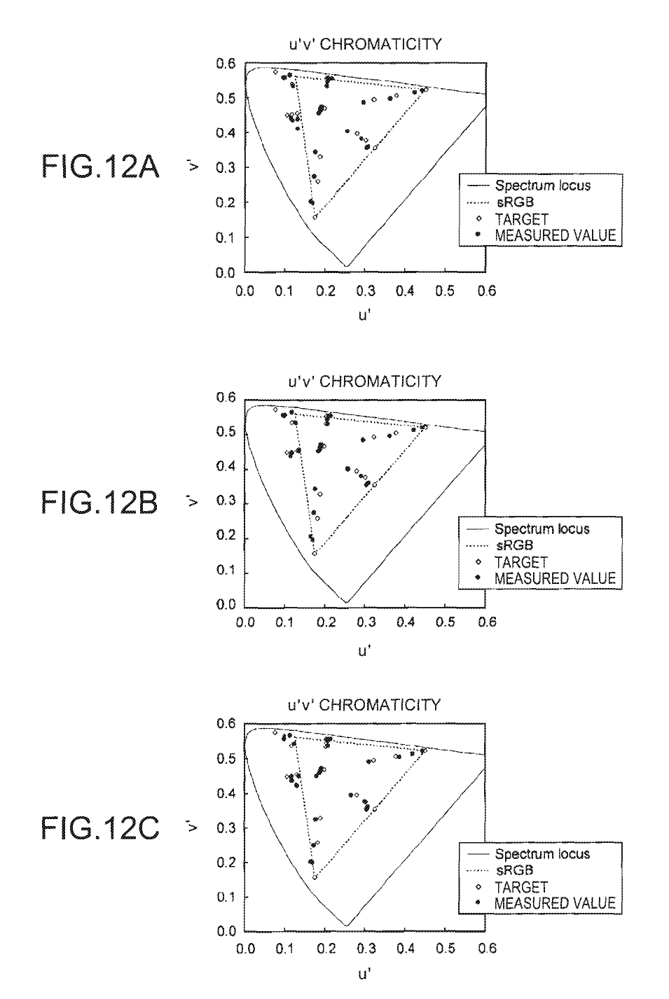

Further, in the case in which the data shown in FIG. 11 is processed by the color conversion circuit 12x, the colors displayed on the display section 20 in accordance with the processed data are measured by a measuring instrument. FIGS. 12A through 12C show a u′ v′ chromaticity plot of the input data (target) and a u′ v′ chromaticity plot with the measured values using the standard YCbCr, the optional RGB, and the expanded color gamut YCbCr systems. FIG. 12A shows the measured values according to the standard YCbCr system, FIG. 12B shows the measured values according to the optional RGB system, and FIG. 12c shows the measured values according to the expanded color gamut YCbCr system.

According to FIGS. 12A through 12C, it proves that in the standard YCbCr, the optional RGB, and the expanded color gamut YCbCr systems, the measured values substantially overlap the input data, and accordingly, reproduction is performed with enough accuracy from a practical point of view. In particular, it proves that with respect to the colors tin the vicinity of Green) in the outside of the color reproduction areas (indicated by the broken lines) of the sRGB, the reproduction is appropriate for either of the standard YCbCr system, the optional RGB, and the expanded color gamut YCbCr system.

As described above, according to the second embodiment, the processing corresponding to various types of standard three-primary-color signals can appropriately be performed, and accordingly, these signals can correctly be reproduced. In other words, in accordance with input of the various standard three-primary-color signals, the color space information of an image can be reproduced with good accuracy.

### Third Embodiment

A third embodiment of the invention will hereinafter be described. The third embodiment is different from the first embodiment and so on in that although in the first and the second embodiments, the display section 20 for performing four-primary-color display is used, in the third embodiment, a display section for performing three-primary-color display is used. In other words, in the third embodiment, the configuration according to the embodiments described above is applied to a configuration using the display section performing the three-primary-color display.

For details, in the third embodiment, the display section displays an image using R, G, and B (Red, Green, and Blue). Basically, the configuration of the image display apparatus according to the third embodiment is substantially the same as the configuration (see FIG. 1) of the image display apparatus 100, and the color conversion circuit also has substantially the same configuration as that of the color conversion circuit 12. It should be noted that in the third embodiment, the color conversion circuit does not perform the color conversion from the three-primary-color system to the four-primary-color system (specifically, the color conversion circuit only includes the YCbCr→RGB conversion section 12a and the RGB→RGB conversion section 12b, but does not include the circuit for performing the color conversion from the three-primary-color system to the four-primary-color system), and the display section performs the three-primary-color display. In other words, the image display apparatus according to the third embodiment only performs is the YCbCr→RGB conversion and the RGB→RGB conversion in the color conversion circuit, and displays the converted data (the three-primary-color data in the Adobe RGB system) on the display section. It should be noted that the YCbCr→RGB conversion is performed using Formulas 1 and 2 described above, and the RGB→RGB conversion is performed using Formulas 3 through 6 described above.

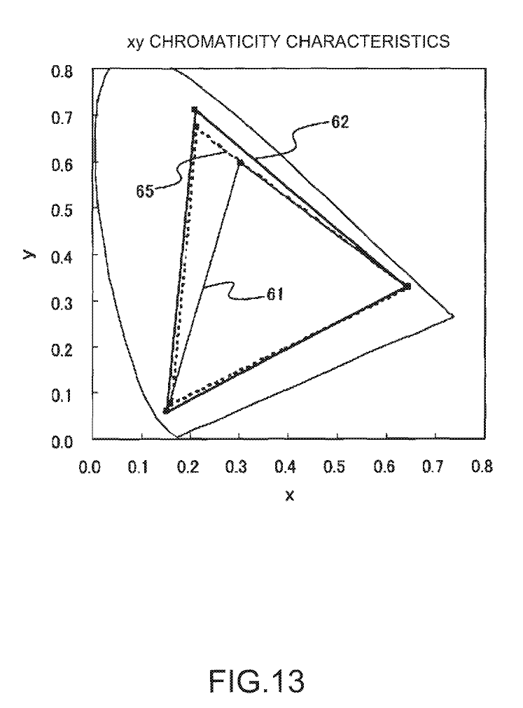

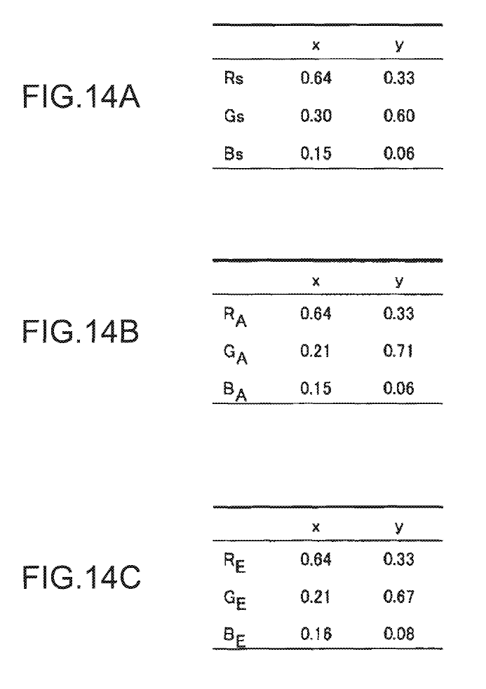

FIG. 13 is a diagram showing the color reproduction areas in comparison with each other in the xy chromaticity diagram in a third embodiment of the invention. The triangle (the triangle formed of the R_{S}, G_{S}, and B_{S} described above) denoted with the reference numeral 61 shows the color reproduction area in the sRGB system, and the triangle (the triangle formed of the R_{A}, G_{A}, and B_{A} described above) denoted with the reference numeral 62 shows the color reproduction area in the Adobe RGB system. The display section in the third embodiment, which uses the three primary colors, R, G, and B, is capable of reproducing the colors inside the triangle denoted with the reference numeral 65 (it should be noted that hereinafter the three primary colors the image display apparatus in the third embodiment can display are also described as “R_{E},” “G_{E},” and “B_{E}”). As is clear from FIG. 13, the image display apparatus according to the third embodiment has a wider color reproduction area than the standard sRGB, and is able to reproduce brighter colors in the emerald greenish colors than in the sRGB system. For reference, FIGS. 14A through 14C show specific numerical values of the xy chromaticity in “R_{S}, G_{S}, B_{S},” “R_{A}, G_{A}, B_{A},” and “R_{E}, G_{E}, B_{E}” described above.

Here, also in the third embodiment, the color conversion circuit is set so as to reproduce the color reproduction area of the Adobe RGB system. Specifically, the color conversion circuit converts the standard three-primary-color signal input thereto into the Adobe RGB system. Further, the display section is configured so as to be able to reproduce the data wp of the Adobe RGB processed in the color conversion circuit

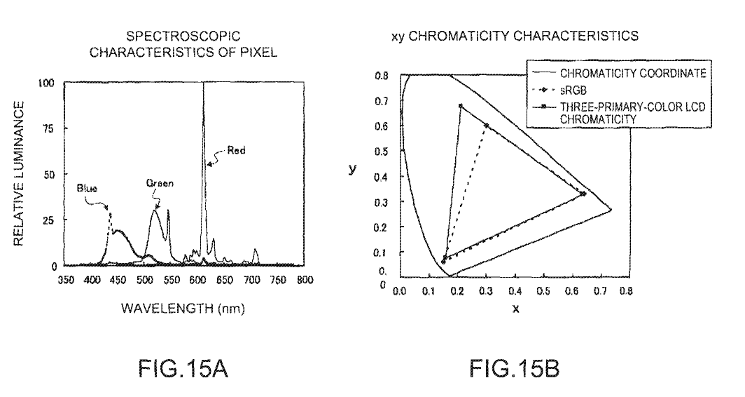

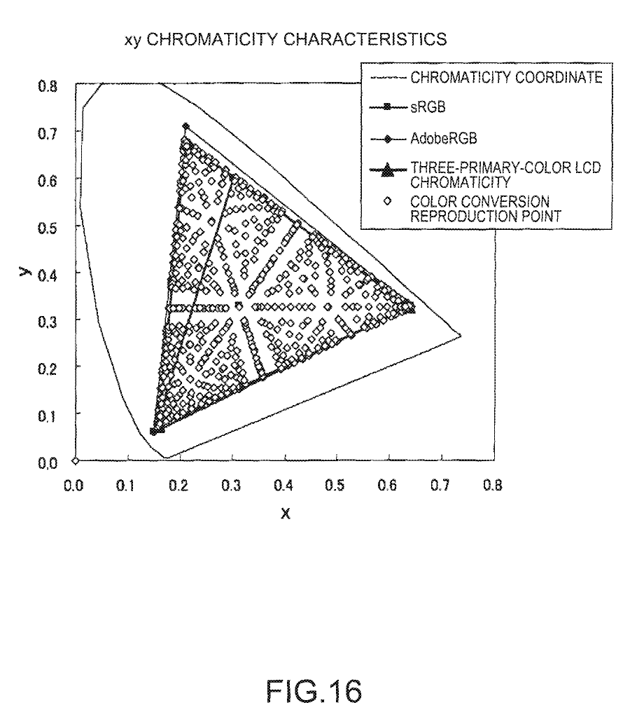

The fact that the color conversion circuit is set so as to reproduce the color reproduction area of the Adobe RGB will hereinafter be explained with reference to FIGS. 15A, 15B, and 16.

FIGS. 15A and 5B are diagrams showing spectroscopic characteristic and so on in each pixel section. FIG. 15A has the horizontal axis representing wavelengths and the vertical axis representing relative luminance and showing the spectroscopic characteristics in light emission of the R, G, and B pixel sections collectively. FIG. 15B is a diagram showing the xy chromaticity characteristics in the sRGB system and the xy chromaticity characteristics in the three-primary-color LCD. In the xy chromaticity characteristics in the three-primary-color LCD, the xy chromaticity is calculated and plotted based on the spectroscopic characteristics in light emission of the R, G, and B pixel sections.

FIG. 16 is a diagram plotting the xy chromaticity of the three-primary-color LCD and the xy chromaticity of colors reproduced by the three-primary-color LCD when inputting the Adobe RGB signal. It should be noted that the points shown in FIGS. 13 and 14C as the triangle (the triangle denoted with the reference numeral 65) represented by R_{E}, G_{E}, and B_{E} correspond to three representative points of the reproduction colors in the three-primary-color LCD shown in FIG. 16.

As described above, in the third embodiment, the standard three-primary-color signal input to the color conversion circuit is converted into the Adobe RGB system, and is displayed on the display section for performing the three-primary-color display of the converted data. Therefore, according to the third embodiment, it becomes possible to perform the color space conversion processing in an unspecified manner even with the display section for performing three-primary-color display. By using such a configuration, the circuit is hardly required to be modified as hardware even in the case of using the display performing the three-primary-color display, and accordingly, the image display apparatus can quickly be designed, thus enhancing the convenience of the designers.

It should be noted that the configuration according to the third embodiment and the configuration according to the second embodiment described above can be combined with each other. Specifically, also by the configuration according to the third embodiment, when either one of the various types of standard three-primary-color signals (the standard YCbCr, the expanded color gamut YCbCr, the standard RGB, and the optional RGB) is input thereto, the processing corresponding to the standard three-primary-color signal input thereto is performed, and the data thus obtained can be displayed on the display section for performing the three-primary-color display. It should be noted that in such a case, the color conversion circuit does not perform the color conversion from the three-primary-color system into the four-primary-color system.

### Modified Example

Although an example of configuring the color conversion circuits 12, 12x as the circuits executing the fixed-point calculation is decried above the number of bits in the fixed point is not limited to those described above Further, the color conversion circuits 12, 12x can be configured as circuits performing floating-point operations.

Further, the chromaticity in the display section 20 for performing the four-primary-color display and the display section for performing the three-primary-color display is not limited to those shown in the example (see FIGS. 3A through 3C, 14A through 14c, and so on). The color conversion circuits 12, 12x shown in the embodiments described above can be applied to other chromaticities.

Further, although as the matrix for performing the YCbCr→RGB conversion on the expanded color gamut YCbCr, the example of “ITU-R BT.601” is presented, it can also be applied to the case with “ITU-R BT.709.” Here, the both sides stipulate the transmission standards of the digital picture signal, wherein the “ITU-R BT.601” is the standard for the standard definition television (SDTV) with 525 scan lines while the “ITU-R BT.709” is the standard for the high definition television (HDTV) with 1125 scan lines.

Further, although the operations performed in the conversion described above is basically assumed to be performed by a circuit, the operations can be performed by software processing. For example, the functions the color conversion circuit 12 has can be realized by an image processing program processed by the CPU (computer), it should be noted that the image processing program can previously be stored in a hard disc or a ROM, or supplied from the outside with a computer readable recording medium such as a CD-ROM, and the image processing program retrieved from the CD-ROM drive can be stored in the hard drive.

The entire disclosure of Japanese Patent Application 2006-304045, filed Nov. 9, 2006 and 2007-217893, filed Aug.24, 2007 are expressly incorporated by reference herein.

What is claimed is:

1. An image processing apparatus for performing processing for converting a color space of image data, comprising:
a color conversion unit that acquires wide color gamut image data and converts the wide color gamut image data into image data in a standard wide color gamut space; and
a transmission unit that transmits the image data converted by the color conversion unit to a display unit capable of displaying the image data in the standard wide color gamut space.

2. The image processing apparatus according to claim 1, wherein the standard wide color gamut space is expressed by Adobe RGB.

3. The image processing apparatus according to claim 1, wherein an xy chromaticity in the standard wide color gamut space is (0.64, 0.33) in red, (0.21 0.71) in green, and (0.15, 0.065) in blue.

4. The image processing apparatus according to claim 1,
wherein, the color conversion unit acquires one of a first luminance color difference signal, a second luminance color difference signal different from the first luminance color difference signal, and a wide color gamut RGB signal as the wide color gamut image data.

5. The image processing apparatus according to claim 4,
wherein the color conversion unit switches processing in accordance with a type of the wide color gamut image data, thereby performing the conversion.

6. An image display apparatus comprising:
an image processing apparatus including
a color conversion unit that acquires wide color gamut image data and converts the wide color gamut image data into image data in a standard wide color gamut space, and
a transmission unit that transmits the image data converted by the color conversion unit to a display section, and
a display unit that displays the image data in a standard wide color gamut space transmitted from the image processing apparatus.

7. The image display apparatus according to claim 6,
wherein the display unit is a liquid crystal display that performs display using four colors, and is configured including a color filter of reds, yellow-green, blue, and emerald-green, and a white LED backlight.

8. The image display apparatus according to claim 6,
wherein the display unit performs display using three colors.

9. An image processing method for performing processing for converting a color space of image data, comprising:
acquiring wide color gamut image data to convert the wide color gamut image data into image data in a standard wide color gamut space; and
transmitting the image data converted in the acquiring step to a display unit capable of displaying the image data in the standard wide color gamut space.

10. A computer readable recording medium storing an image processing program for converting a color space of image data, which makes a computer function as:
a color conversion unit that acquires wide color gamut image data to convert the wide color gamut image data into image data in a standard wide color gamut space; and
a transmission unit that transmits the image data converted in the color conversion unit to a display unit capable of displaying the image data in the standard wide color gamut space.
